(19) United States
(12) Patent Application Publication
(10) Pub. No.: US 2010/0123062 A1
(43) Pub. Date: May 20, 2010

(54) MOUNTING AND RETAINING ARRANGEMENTS FOR HANDHELD DEVICES

(75) Inventors: Jim Jones, Strongsville, OH (US); Ted Collmar, Stronsgville, OH (US)

Correspondence Address: CALFEE HALTER & GRISWOLD, LLP, 800 SUPERIOR AVENUE, SUITE 1400, CLEVELAND, OH, 44114, US

(73) Assignee: THE L.D. KICHLER CO., Cleveland, OH (US)

(21) Appl. No.: 12/617,791

(22) Filed: Nov. 13, 2009

Related U.S. Application Data
(60) Provisional application No. 61/114,652, filed on Nov. 14, 2008.

(51) Int. Cl. F16M 13/00; F16B 21/00

(52) U.S. Cl. 248/222.14; 248/220.21; 403/325

(57) ABSTRACT

A mountable retainer for a handheld device includes a receiver plate and a user operable release latch. The receiver plate is structured to be mounted to a wall surface and includes an inner perimeter wall sized to axially receive the handheld device. The release latch is at least partially disposed on the inner perimeter wall and includes a device retaining member extending laterally inward of the inner perimeter wall for engagement with an outer portion of the handheld device, wherein the release latch is laterally movable from a device engaging position to a device releasing position for removal of the handheld device from the receiver plate.

### CROSS-REFERENCE TO RELATED APPLICATION

This application claims priority to, and any other benefit of, U.S. Provisional Patent Application Ser. No. 61/114,562, entitled MOUNTING AND RETAINING ARRANGEMENTS FOR HANDHELD DEVICES and filed Nov. 14, 2008, the entire disclosure of which is fully incorporated herein by reference.

### BACKGROUND

Handheld devices, such as, for example, a remote control console for an entertainment system or component or for a fan, lighting unit, or other fixture, provide portability and convenience of use. In the case of a remote control console, however, the portability and small size of the console can result in the console being misplaced, offsetting the convenience of remote operation of the component or fixture.

### SUMMARY

The present application contemplates arrangements for releasably mounting and/or retaining handheld devices, for example, on a wall surface or other structure, which may combine the convenience of a portable control device with the predictability and ease of access of a wall control console. In one such embodiment, a mountable retainer for a handheld device includes a receiver plate and a user operable release latch. The receiver plate is structured to be mounted to a wall surface and includes an inner perimeter wall sized to axially receive the handheld device. The release latch is at least partially disposed on the inner perimeter wall and includes a device retaining member extending laterally inward of the inner perimeter wall for engagement with an outer portion of the handheld device, wherein the release latch is laterally movable from a device engaging position to a device releasing position for removal of the handheld device from the receiver plate.

In another embodiment, a mountable retainer for a handheld device further includes a device ejector disposed on the mounting member and positioned to engage an axially inward surface of the handheld device when the handheld device is retained in the mounting member. The device ejector is resiliently biased in an axially outward direction, such that when the handheld device is retained in the mounting member, movement of the release latch to the device releasing position allows the device ejector to bias the handheld device axially outward of the mounting member for user grasping.

The present application also contemplates methods for releasably mounting and/or retaining handheld devices, for example, on a wall surface or other structure. In one such method, a mountable retainer for a handheld device is provided. The mountable retainer includes a receiver plate and a user operable release latch, with the receiver plate including an inner perimeter wall sized to axially receive a handheld device. The release latch is at least partially disposed on the inner perimeter wall and includes a device retaining member extending laterally inward of the inner perimeter wall for engagement with an outer portion of the handheld device. The mountable retainer is mounted to a wall of a structure. A handheld device is positioned within the inner peripheral wall of the receiver plate, such that the release latch releasably engages an engageable portion of the handheld device.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention, wherein:

FIG. 1A is a front schematic view of a handheld device and a mountable retainer for receiving the device;

FIG. 1B is a side schematic view of a handheld device and a mountable retainer for receiving the device;

FIGS. 2A-2H are various views of an exemplary embodiment of a handheld device and a mountable retainer for receiving the device, shown with the handheld device secured by the mountable retainer;

FIGS. 3A-3G are various views of the exemplary handheld device of FIGS. 2A-2H;

FIG. 4 is a front view of an exemplary embodiment of a handheld device and a mountable retainer for receiving the device, shown with the handheld device removed from the mountable retainer;

FIG. 5 is a front view of the mountable retainer of FIG. 4;

FIG. 6A is a front view of the mountable retainer of FIG. 4, shown with the base portion of the retainer disassembled from the receiver portion of the retainer;

FIG. 6B is a rear view of the mountable retainer of FIG. 4, shown with the base portion of the retainer disassembled from the receiver portion of the retainer;

FIG. 7 is a partial side perspective view of the base portion of the mountable retainer of FIG. 4;

FIG. 8 is a lower front perspective view of the base portion of the mountable retainer of FIG. 4, shown with the device ejector disassembled from the base portion; and

FIG. 9 is a rear view of the device ejector of the mountable retainer of FIG. 4.

### DESCRIPTION

While the present application describes exemplary embodiments including mounting and retaining arrangements for remote control devices, such as, for example, a remote control console for a ceiling fan, it is to be understood that many of the inventive features of the present application may be utilized with other types of handheld devices, such as, for example, other handheld electronic equipment (e.g., cameras, communication devices, video displays, etc.).

According to an inventive aspect of the present application, a mountable retainer for a handheld device may include a mounting member structured to be mounted to a wall surface of a room, door, cabinet, or other such structure. The mounting member is structured to axially (i.e., in a direction substantially perpendicular to the wall surface) receive the handheld device for releasable retention of the handheld device on the wall surface. In one embodiment, the mountable retainer includes a user operable (e.g., graspable or manipulable) release latch structured to engage an outer portion of the handheld device. The release latch is movable from a device engaging position to a device releasing position for removal of the handheld device from the mounting member. Other configurations or mechanisms for retaining a device may additionally or alternatively be provided, such as, for example, Velcro® patches, snaps, or other such components.

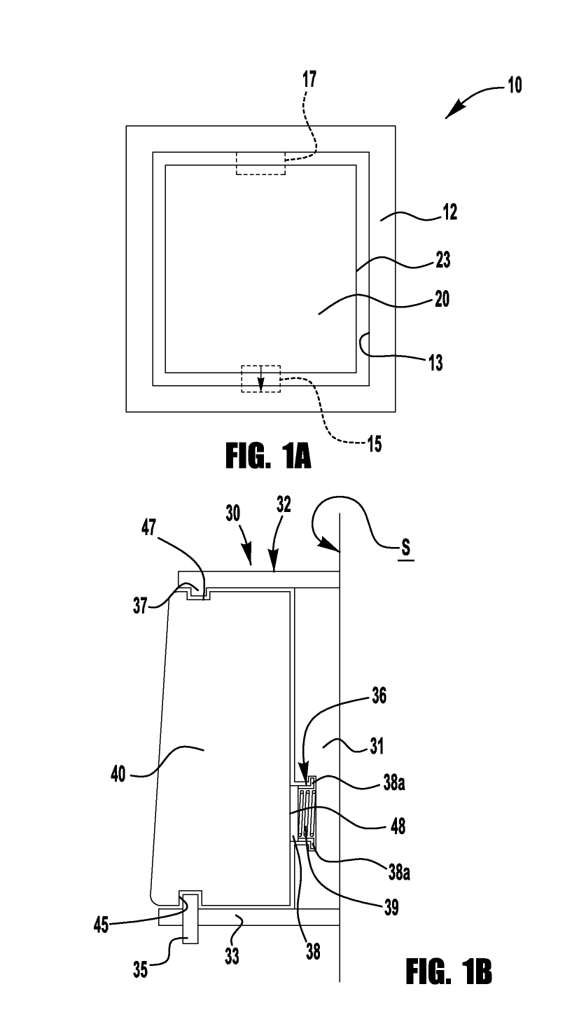

FIG. 1A schematically illustrates a front view of a mountable retainer 10 for a handheld device 20. The mountable retainer 10 includes a mounting member 12 sized to axially receive the device 20. While the mounting member 12 may take many different shapes and forms, in one embodiment, the mounting member 12 includes an inner perimeter wall 13 sized to receive the handheld device 20 therein. The handheld device may include a complementary shaped outer perimeter wall 23, giving the retained device a flush or continuous appearance within the mountable retainer.

To releasably retain the handheld device 20 within the mountable retainer 10, a release latch, such as exemplary release latch 15, extends to engage a portion of the handheld device. The exemplary release latch 15 shown is user operable for movement from a device engaging position (as shown in FIG. 1A) to a device releasing position (i.e., disengageable from the outer portion of the device) for removal of the device 20 from the mounting member 12. The release latch 15 may be structured for many different types of user manipulation, including, for example, axial (pulling or pushing), lateral (sliding), or rotational (twisting) movement of the latch, or some combination of these movements. While the exemplary release latch 15 is illustrated as engaging a lower edge of the device 20, the latch may be located or structured to releasably engage any location or portion of the device, including portions laterally inward from the outer perimeter of the device. Additionally, one or more fixed, laterally inward extending projections 17 may be provided on the inner perimeter wall of the mounting member 12 to facilitate retention of the device 20 prior to its release.

According to another inventive aspect of the present application, the mountable retainer may be structured to facilitate withdrawal of the released handheld device by biasing the device axially outward for user grasping. In one embodiment, a device ejecting member or device ejector may be positioned to engage an axially inward or rear surface of the handheld device when the device is retained in the mounting member to bias the device outward when the device is released for withdrawal (e.g., by a release latch, as described above). In one embodiment, a device ejector may be assembled with a base plate of the mounting member for engagement of the rear surface of the retained handheld device.

FIG. 1B schematically illustrates a side cross-sectional view of a mountable retainer 30 (mounted to a wall surface S) and a handheld device 40 secured within the retainer 30. The mountable retainer 30 includes a mounting member 32 having a base portion 31 and a receiver portion 33 for receiving the device 40. An exemplary release latch 35 is assembled with the mounting member 32 for releasably engaging a notch 45 (or other engageable portion) of the device 40. To facilitate withdrawal of the released device 40 from the mounting member 32, a device ejector 38 is assembled with the base portion 31 for axially outward biased engagement with a rear surface 48 of the device 40. When the release latch 35 is moved to a device releasing position, the device ejector 38 is biased outward by spring member 39 to force the device 40 axially outward for user grasping. While the device ejector 38 is shown assembled with the base portion 31, other arrangements may be provided, including, for example, connection of a device ejector with the outer receiving portion, or inclusion of a separate device ejector compressed between the device and the wall surface to which the mounting member is mounted.

In the illustrated embodiment of FIG. 1B, the device ejector 38 and the spring member 39 are seated in a recess 36 in the base portion 31, such that the compressed device ejector 38 is substantially flush with the front surface of the base portion 31 when the device 40 is secured in the mounting member 32. Further, the device ejector 38 may be movably connected to the base portion 31 (for example, by one or more retaining legs 38a) to prevent the device ejector 38 from coming dislodged from the base portion 31 when the device 40 is removed from the mounting member 32.

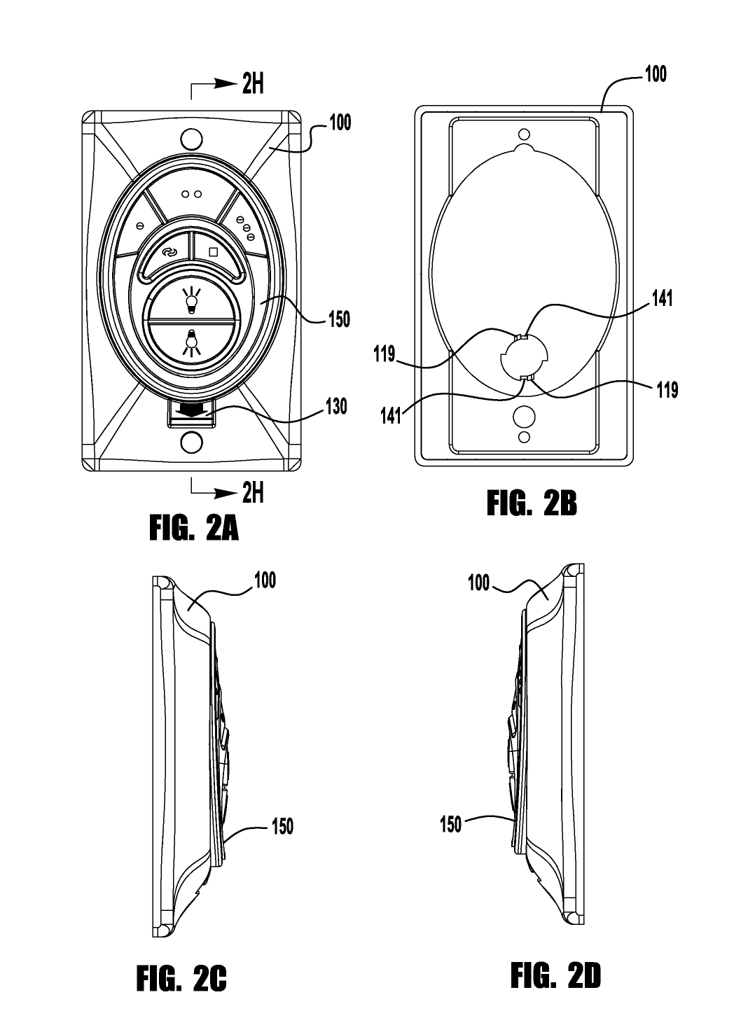

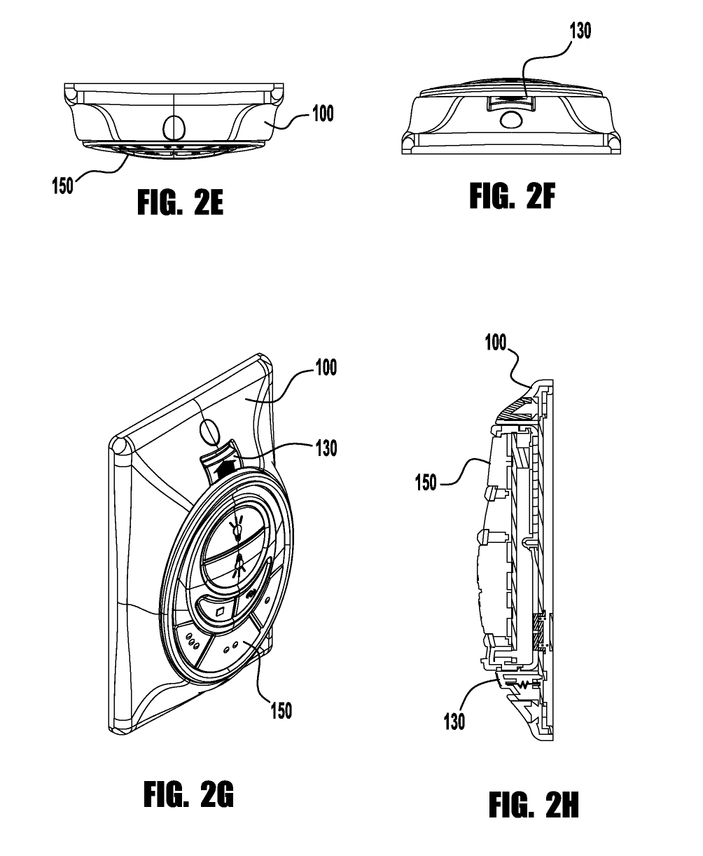

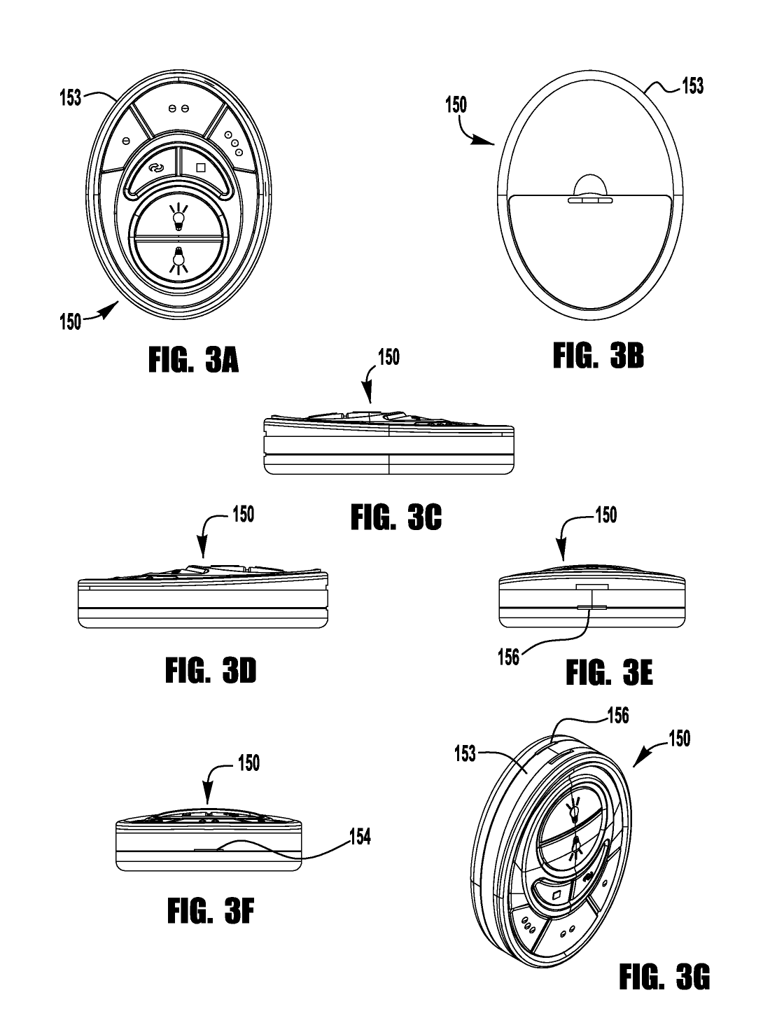

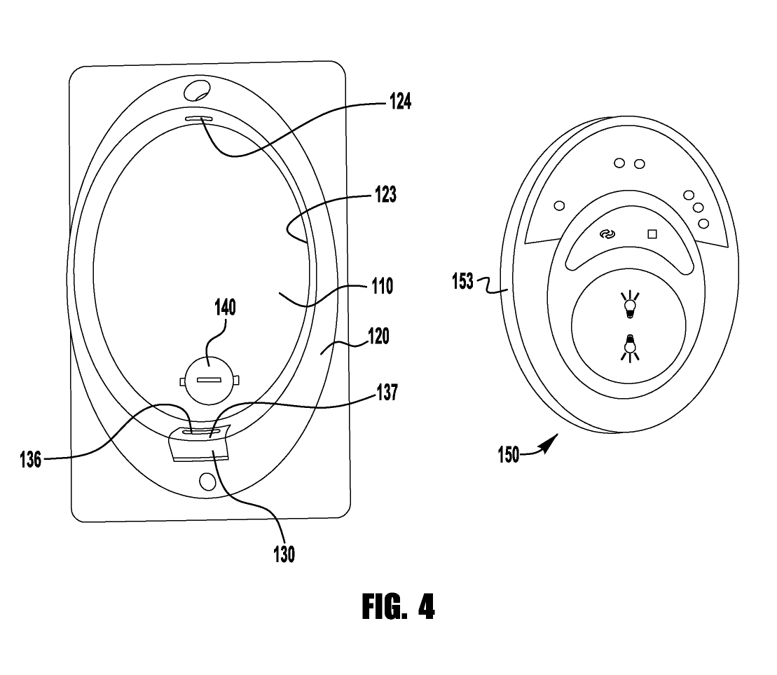

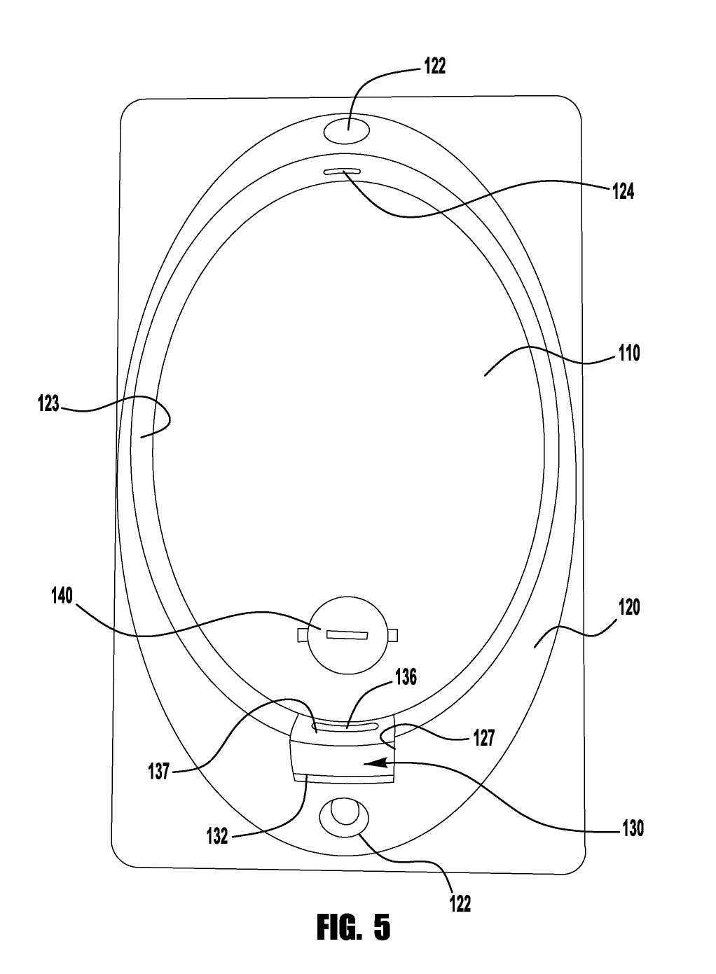

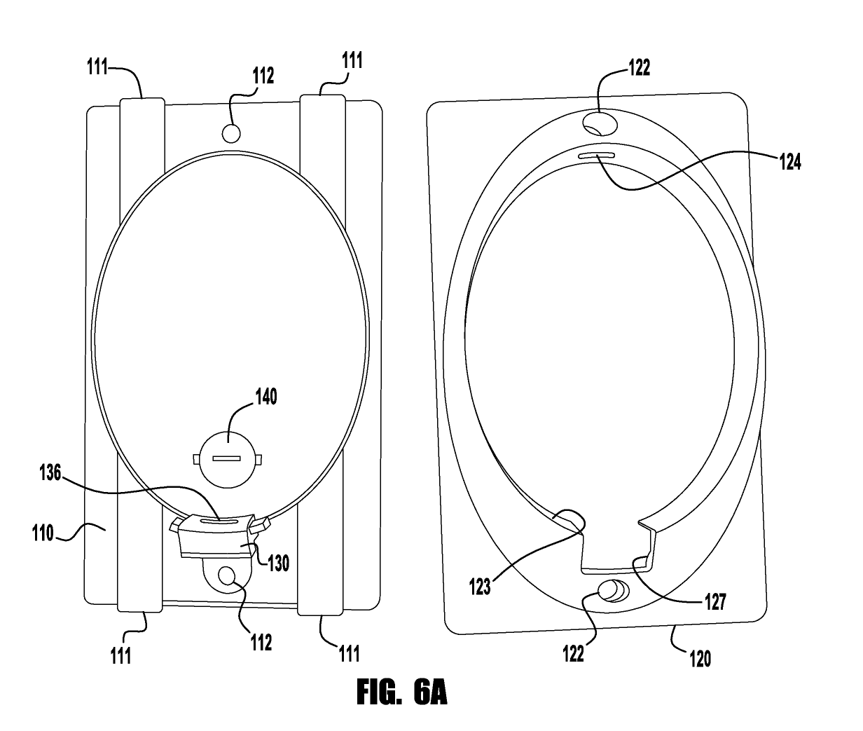

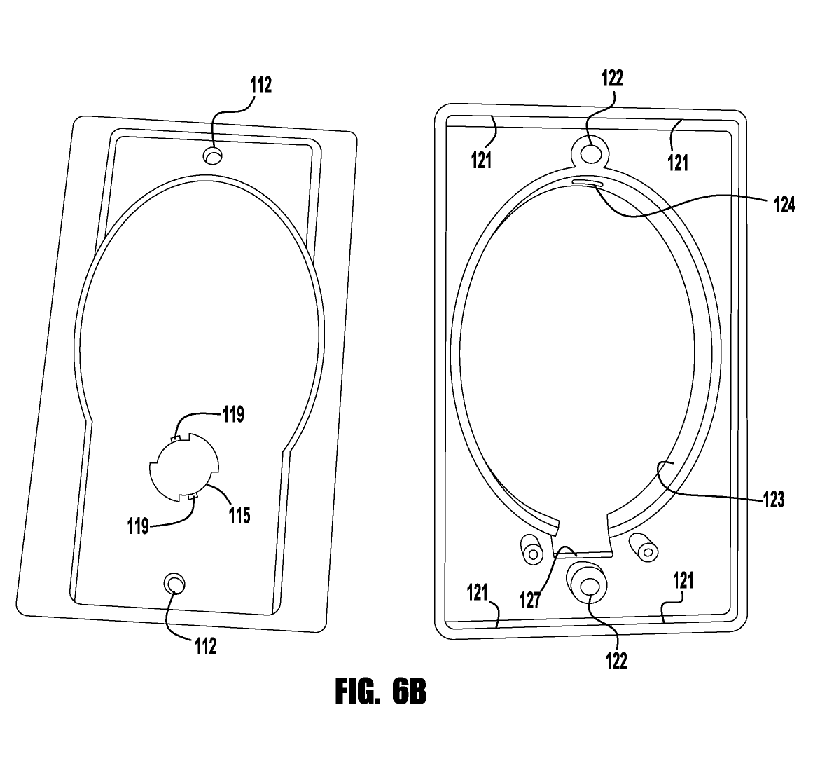

FIGS. 2A-2H illustrate various views of an exemplary mountable retainer 100 for use with an exemplary remote control device or transmitter 150, and FIGS. 3A-3G illustrate various views of the transmitter 150. FIGS. 4-9 include various views of a mountable retainer and its components. As shown in FIGS. 5, 6A, and 6B, the mountable retainer 100 includes a base plate 110, a receiver plate 120, a release latch 130, and a device ejector 140. The receiver plate 120 is attachable to the base plate 110, for example, by snap fit engagement between base plate tabs 111 that interlock with corresponding recesses 121 in the receiver plate 120. The base plate 110 and receiver plate 120 include aligned mounting holes 112, 122 for mounting the retainer 100 to a wall surface (e.g., using machine screws or other fasteners), although other mounting arrangements may be utilized. In one embodiment, the mounting holes 112, 122 may be dimensioned to align with mounting holes in a conventional outlet box, such that the mounted device 150 may functionally and positionally replace a conventional wall switch. The receiver plate 120 includes an inner perimeter wall 123 sized to closely receive an outer perimeter wall 153 of the device 150. A laterally inward extending projection 124 is disposed on the inner perimeter wall 123 for engagement with a corresponding notch 154 in the device 150, to facilitate retention of the device 150 prior to its release.

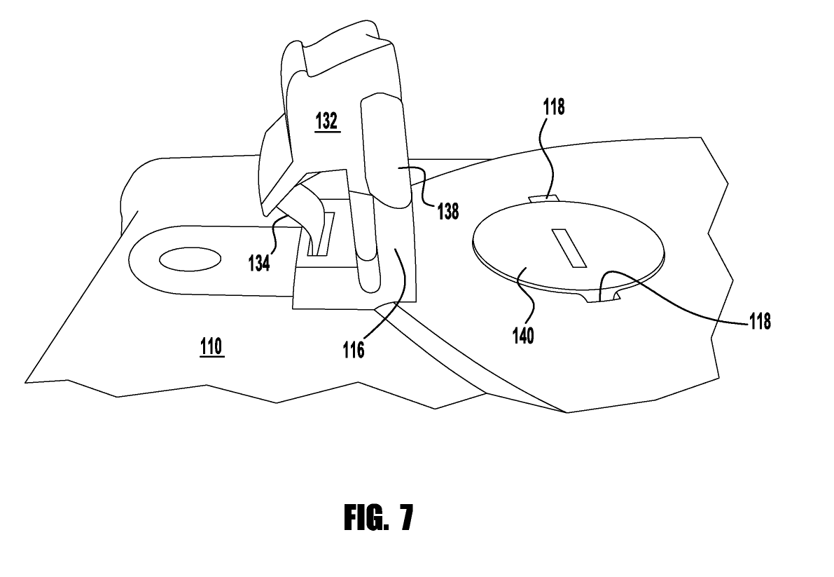

The exemplary release latch 130 includes a laterally movable device engaging member 132 having a laterally inward extending projection 136 for engagement with a corresponding notch 156 in the outer perimeter wall 153 of the device 150. The device engaging member 132 is attached to the base plate 110 by a resilient spring plate 134 (see FIG. 7) that is bent (or otherwise formed) to be biased laterally inward toward engagement with the device 150. As shown, the release latch 130 may extend into a gap 127 in the inner perimeter wall 123 of the receiver plate 120, such that a laterally inner surface 137 of the device engaging member 132 is substantially flush with the inner perimeter wall 123. Laterally inward movement of the device engaging member 132 may be limited, for example, by a wall segment 116 extending axially outward from the base portion 110, and/or by side flanges 138 received behind the inner perimeter wall 123 on either side of the gap 127.

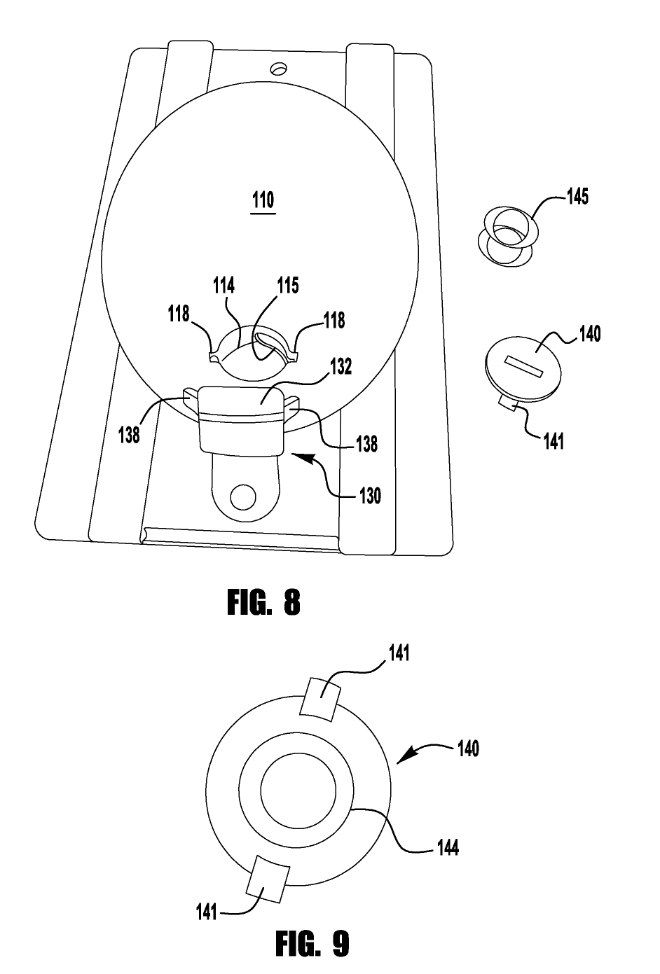

The exemplary device ejector 140 is a button shaped member sized to be seated or received in a corresponding recess 114 in the base plate 110, with a spring 145 compressed between the device ejector 140 and the base plate 110 (see FIG. 8). A post 144 may be provided on the rear surface of the device ejector 140 (see FIG. 9), for example, to facilitate centering of the spring 145. The device ejector 140 includes a pair of laterally extending arms or tabs 141 that are axially received through corresponding notches 118 in the recess 114 for rotational engagement with a circumferential slot 115 in the recess 114, the slot width being structured for outward biasing of the device ejector 140 beyond a front surface of the base plate 110. The rear surface of the base plate 110 may include nibs 119 (see FIG. 6B) that allow the tabs 141 to snap into a rotationally secured position for secure, movable attachment between the base plate 110 and the device ejector 140. When the device 150 is retained in the mountable retainer 100, the rear surface of the device 150 compresses the device ejector 140, such that the front surface of the device ejector 140 is substantially flush with the front surface of the base plate 110. When the release latch 130 is moved laterally out of engagement with the device 150 (disengaging the projection 136 from the corresponding notch 156), the compressed spring 145 forces the device ejector 140 and the device 150 axially outward, to facilitate user grasping of the device 150.

In one embodiment, as shown, the outer perimeter wall 153 of the device is provided with 180° overall rotational symmetry and substantially similar notches 154, 156, allowing the device 150 to be retained in the mountable retainer in two different orientations (e.g., right-side up, and upside down).

While many different materials may be utilized to construct a mountable retainer having one or more of the inventive features described herein, in one embodiment, the base plate, receiver plate, device engaging member, and device ejector are provided in injection molded plastic (e.g., ABS plastic), and the spring and spring plate are provided in a metal material (e.g., spring steel).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated. Also, the various features of the lighting products discussed above and claimed below may be considered to be separate building blocks which may provide utility in and of themselves. Thus, it is contemplated that inventive devices and arrangements may be designed based on the teachings herein using virtually any combination or permutation of any one or more of these separate features without necessarily some or all of the other features. Accordingly, it is contemplated that arrangements, devices, and combinations of devices may be claimed using virtually any combination or permutation of any one or more of these features.

1. A mountable retainer for a handheld device, the mountable retainer comprising:
a receiver plate structured to be mounted to a wall surface, the receiver plate including an inner perimeter wall sized to axially receive the handheld device; and
a user operable release latch at least partially disposed on the inner perimeter wall, the release latch including a device retaining member extending laterally inward of the inner perimeter wall for engagement with an outer portion of the handheld device, wherein the release latch is laterally movable from a device engaging position to a device releasing position for removal of the handheld device from the receiver plate.

2. The mountable retainer of claim 1, further comprising a device ejector disposed laterally inward of the inner perimeter wall and positioned to engage an axially inward surface of the handheld device when the handheld device is retained in the receiver plate, the device ejector being resiliently biased in an axially outward direction, such that when the handheld device is retained in the receiver plate, lateral movement of the release latch to the device releasing position allows the device ejector to bias the handheld device axially outward of the inner perimeter wall for user grasping.

3. The mountable retainer of claim 2, wherein the device ejector is assembled with a base plate extending laterally inward of the inner perimeter wall.

4. The mountable retainer of claim 3, further comprising a spring member disposed axially between the base plate and the device ejector.

5. The mountable retainer of claim 1, wherein the receiver plate includes a second device retaining member extending laterally inward from the inner perimeter wall for engagement with a second outer portion of the handheld device, the second device retaining member being circumferentially spaced from the first stated device retaining member.

6. The mountable retainer of claim 1, wherein the release latch is resiliently biased toward the device engaging position.

7. The mountable retainer of claim 1, wherein the release latch is connected to one of the receiver plate and a base plate axially inward of the inner perimeter wall by a laterally inward biased spring plate.

8. The mountable retainer of claim 1, wherein the receiver plate includes mounting apertures positioned for mounting the receiver plate to a light switch outlet box.

9. The mountable retainer of claim 1, further comprising:
a base plate extending laterally inward of the inner perimeter wall;
a device ejector assembled with the base plate and disposed laterally inward of the inner perimeter wall and positioned to engage an axially inward surface of the handheld device when the handheld device is retained in the receiver plate, the device ejector being resiliently biased in an axially outward direction, such that when the handheld device is retained in the receiver plate, lateral movement of the release latch to the device releasing position allows the device ejector to bias the handheld device axially outward of the inner perimeter wall for user grasping; and
a spring member disposed axially between the base plate and the device ejector;
wherein the device ejector is seated in a recessed portion of the base plate, such that the device ejector is substantially flush with an axially outer surface of the base plate when the handheld device is retained in the receiver plate.

10. The mountable retainer of claim 9, wherein receiver plate includes a second device retaining member extending laterally inward from the inner perimeter wall for engagement with a second outer portion of the handheld device, the second device retaining member being circumferentially spaced from the first stated device retaining member, and further wherein the release latch is connected to one of the receiver plate and the base plate by a laterally inward biased spring plate

11. A mountable retainer for a handheld device, the mountable retainer comprising:
a mounting member structured to be mounted to a wall surface, the mounting member being structured to axially receive the handheld device;
a user operable release latch structured to engage an outer portion of the handheld device, wherein the release latch is movable from a device engaging position to a device releasing position for removal of the handheld device from the mounting member; and
a device ejector disposed on the mounting member and positioned to engage an axially inward surface of the handheld device when the handheld device is retained in the mounting member, the device ejector being resiliently biased in an axially outward direction, such that when the handheld device is retained in the mounting member, movement of the release latch to the device releasing position allows the device ejector to bias the handheld device axially outward of the mounting member for user grasping.

12. The mountable retainer of claim 11, further comprising a spring member disposed axially between the base plate and the device ejector.

13. The mountable retainer of claim 11, wherein the device ejector is seated in a recessed portion of the mounting member, such that the device ejector is flush with a device contacting surface of the mounting member when the handheld device is retained in the mounting member.

14. The mountable retainer of claim 11, wherein the mounting member comprises a receiver plate defining an opening for axially receiving the handheld device therethrough, and a base plate assembled with the receiver plate and at least partially disposed axially inward of the opening.

15. The mountable retainer of claim 14, wherein the device ejector is assembled with the base plate.

16. The mountable retainer of claim 11, wherein the receiver plate includes mounting apertures for wall mounting with machine screws.

17. The mountable retainer of claim 16, wherein the mounting apertures are positioned for mounting the receiver plate to a light switch outlet box.

18. In combination, a handheld device including an outer perimeter wall extending axially between opposed front and rear surfaces; and a mountable retainer for releasable retaining the handheld device, the mountable retainer comprising:
a receiver plate structured to be mounted to a wall surface, the receiver plate including an inner perimeter wall sized to axially receive the handheld device; and
a user operable release latch at least partially disposed on the inner perimeter wall, the release latch including a device retaining member extending laterally inward of the inner perimeter wall for engagement with a retained portion of the outer perimeter wall of the handheld device, wherein the release latch is laterally movable from a device engaging position to a device releasing position for removal of the handheld device from the receiver plate.

19. The combination of claim 18, wherein the inner perimeter wall of the receiver plate is sized to closely receive the outer perimeter wall of the handheld device.

20. The combination of claim 18, wherein the inner perimeter wall of the receiver plate extends axially outward to a front edge that is substantially flush with the front surface of the handheld device when the handheld device is retained within the mountable retainer.

21. The combination of claim 18, wherein the device retaining member includes a laterally inward extending projection positioned to interlock with the retained portion of the handheld device when the handheld device is retained within the mountable retainer.

22. The combination of claim 21, wherein the retained portion comprises a notch sized to receive the projection of the device retaining member when the handheld device is retained within the mountable retainer.

23. The combination of claim 18, wherein the inner perimeter wall of the retainer plate includes a laterally inward extending projection and the outer perimeter wall of the handheld device includes a notch positioned to receive the projection when the handheld device is retained within the mountable retainer.

24. In combination, a handheld device including an outer perimeter wall extending axially between opposed front and rear surfaces; and a mountable retainer for releasable retaining the handheld device, the mountable retainer comprising:
a mounting member structured to be mounted to a wall surface, the mounting member being structured to axially receive the handheld device;
a user operable release latch structured to engage a laterally outer portion of the handheld device, wherein the release latch is movable from a device engaging position to a device releasing position for removal of the handheld device from the mounting member; and
a device ejector disposed on the mounting member and positioned to engage the rear surface of the handheld device when the handheld device is retained in the mounting member, the device ejector being resiliently biased in an axially outward direction, such that when the handheld device is retained in the mounting member, movement of the release latch to the device releasing position allows the device ejector to bias the handheld device axially outward of the mounting member for user grasping.

25. A method, comprising:
providing a mountable retainer comprising a receiver plate including an inner perimeter wall sized to axially receive a handheld device and a user operable release latch at least partially disposed on the inner perimeter wall and includes a device retaining member extending laterally inward of the inner perimeter wall for engagement with an outer portion of the handheld device;
mounting the mountable retainer to a wall of a structure; and
positioning a handheld device within the inner peripheral wall of the receiver plate, such that the release latch releasably engages an engageable portion of the handheld device.

26. The method of claim 25, wherein the handheld device comprises a remote control for controlling at least one of a light source and a fan in a room, and further comprising selecting the wall for mounting the mountable retainer in the same room as the light source or fan is mounted or to be mounted.

27. The method of claim 25, wherein the mountable retainer is mounted in place of an existing electrical switch.

28. The method of claim 25, wherein the mountable retainer is mounted to an electrical outlet box.

29. The method of claim 25, wherein the mountable retainer is mounted on the wall between 3 feet and 6 feet above a floor adjacent to the wall.

30. The method of claim 25, further comprising moving the release latch from a device engaging position to a device releasing position for removal of the handheld device from the receiver plate.
